(19) United States
(12) Patent Application Publication
(10) Pub. No.: US 2014/0068314 A1
(43) Pub. Date: Mar. 6, 2014

(54) PORTABLE ELECTRONIC DEVICE AND METHOD FOR MANAGING BATTERY POWER CONSUMPTION

(71) Applicant: Pantech Co., Ltd., Seoul (KR)

(72) Inventors: Hyun KIM, Seoul (KR); Woo-Jin Lee, Seoul (KR)

(73) Assignee: Pantech Co., Ltd., Seoul (KR)

(21) Appl. No.: 13/973,721

(22) Filed: Aug. 22, 2013

(30) Foreign Application Priority Data
Aug. 31, 2012 (KR) 10-2012-0096711

(51) Int. Cl. G06F 1/28

(52) U.S. Cl. CPC G06F 1/28
USPC 713/340

(57) ABSTRACT

Terminals, apparatuses and methods for managing battery power consumption in a device, including: one or more battery consumption elements; a battery consumption management device to determine a real time power consumption of the one or more battery consumption elements and to determine a power consumption status of the one or more battery consumption elements based on the determined real time power consumption; and a controller to control operations of the one or more battery consumption elements and the battery consumption management device and to provide real-time battery consumption information corresponding to the determined power consumption status. Accordingly, by providing the real-time battery consumption information, operation of the one or more battery consumption elements of the device may selectively stopped or continued based on the provided real-time battery consumption information and, therefore, battery power consumption may be more efficient.

### CROSS-REFERENCE TO RELATED APPLICATION

This application claims priority to and the benefits under 35 U.S.C. §119(a) of a Korean Patent Application No. 10-2012-0096711, filed on Aug. 31, 2012, the contents of which are herein incorporated in its entirety by reference for all purposes as if fully set forth herein.

### BACKGROUND

1. Field

Exemplary embodiments relate to a portable electronic device, and more particularly, to a portable electronic device having a battery management operation.

2. Discussion of the Background

With the development of information and communication technology, a wide variety of portable electronic devices have been developed, and performance of the portable electronic devices has increased. Portable electronic devices may include, for example, cellular phones, smart phones, tablet computers, MPEG audio layer-3 (MP3) players, digital cameras, portable multimedia players (PMPs), navigation devices, portable game players, electronic dictionaries, and electronic-book (E-book) readers, for example. Portable electronic devices may receive power through an independent power source, such as a battery. Presently, a rechargeable secondary battery is typically used as the battery for portable electronic devices. Although the secondary battery is becoming more efficient due to the advancement of battery-related technology, since portable electronic devices are showing a tendency to become relatively more lightweight and slim, it typically is not easy to increase the capacity of the battery, such as where reduced size and weight constraints are placed on the design of the portable electronic device.

A battery power remaining time of a portable electronic device configured to receive power through a battery typically depends on a battery usage level of the portable electronic device. To offer convenience to users, battery usage level information is displayed on a display in most portable electronic devices. In general, the battery usage level information is displayed in the form of numbers or images on a status display region of a portable electronic device. A user may predict a time duration (hereinafter, referred to as a backup time) for which the corresponding portable electronic device may be used going forward in time, based on the battery usage level information, and control consumption of a battery. In particular, since an electronic device with a relatively simple operation has an almost constant power consumption per unit time, the user may very precisely predict a backup time for a given battery usage level.

However, portable electronic devices are becoming more multi-operational due to digital convergence caused by the development of digital technology. Thus, modules having various operations are also mounted on the portable electronic devices. For example, not only various wireless communication modules (e.g., a mobile communication module, a WiFi module, and a Bluetooth module) and various sensors (e.g., an acceleration sensor, a gravity sensor, and a touch sensor), but also a camera module, a global positioning system (GPS) module, a display module, an audio input/output (I/O) module, a vibration generation module, and a broadcasting receiving module may be integrated in a portable electronic device, such as a smart phone or a tablet computer. When a specific application is executed in a portable electronic device, only one related module may be driven, or a plurality of related modules may be simultaneously, or at approximately the same time, driven according to the kind of application or applications being executed by the portable electronic device.

In addition, with the improvement of the performance of portable electronic devices, a multi-tasking operation is typically provided. Moreover, due to the multi-tasking operation of portable electronic devices, not only the number of applications that may be driven at the same time, or at approximately the same time, but also speeds at which the applications are driven, are on the increase. To support the increased number and speed of applications, hardware performance of portable electronic devices is generally improving, as well. For example, the processing speed of a central processing unit (CPU) of a portable electronic device likewise, increases, as well as the number of cores increases, and the capacity of a random access memory (RAM) also gradually increases, for example.

In more recent portable electronic devices, power consumption per unit time may greatly vary according to an operation state of the portable electronic device. This is because the number of applications simultaneously driven in a CPU, the used amount of RAM, the number of operating modules, and a wireless network state, is typically variable. In this case, it may be hard for a user to comprehend or predict the backup time of the corresponding portable electronic device based only on battery usage level information. As a result, a user may experience some inconvenience. That is, the user cannot use the portable electronic device when a battery's power is completely consumed earlier than predicted, or cannot perform necessary operations promptly to save the battery's power.

### SUMMARY

Exemplary embodiments of the present invention relate to devices, apparatuses and systems having a battery management operation and methods for managing battery power consumption in devices, apparatuses and systems, by which a user may easily comprehend a battery consumption status of a multi-operational device having various operation states.

Also, exemplary embodiments of the present invention relate to devices, apparatuses and systems having a battery management operation and methods for managing battery power consumption in devices, apparatuses and systems, by which a user may effectively control use of the device according to a battery usage level.

Exemplary embodiments relate to a device to manage battery power consumption, including: one or more battery consumption elements; a battery consumption management device to determine a real time power consumption or the one or more battery consumption elements and to determine a power consumption status of the one or more battery consumption elements based on the determined real time power consumption; and a controller to control operations of the one or more battery consumption elements and the battery consumption management device and to provide real-time battery consumption information corresponding to the determined power consumption status.

Exemplary embodiments also relate to a method for managing battery power consumption of a device, including: determining a real time power consumption or one or more battery consumption elements of a device; determining a power consumption status of the one or more battery consumption elements based on the determined real time power consumption; and providing real-time battery consumption information corresponding to the determined power consumption status.

Embodiments of the present invention further relate to a method for managing battery power consumption of a device, including: setting at least one updating period to update real-time battery consumption information of a device; setting a status level range for a corresponding status level of the real-time power consumption; determining real-time power consumption of one or more battery consumption elements of the device at a corresponding updating period of the one or more set updating periods; determining a status level of the real-time power consumption for the one or more battery consumption elements based on the determined real-time power consumption for the corresponding updating period; and providing the real-time battery consumption information including the determined status level of the real-time power consumption for the one or more battery consumption elements for the corresponding updating period.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a portable electronic device having a battery management operation according to exemplary embodiments of the present invention.

FIG. 2 is a block diagram of an example of a battery consumption management device of the portable electronic device of FIG. 1 according to exemplary embodiments of the present invention.

FIG. 3 is a block diagram of the battery management device of FIG. 2, which is formed on an operating system (OS) of a portable electronic device according to exemplary embodiments of the present invention.

FIG. 4 is a flowchart illustrating methods for managing a battery for a portable electronic device according to exemplary embodiments of the present invention.

FIG. 5 is a flowchart illustrating methods for managing a battery for a portable electronic device according to exemplary embodiments of the present invention.

FIG. 6A is a diagram illustrating real-time battery consumption information displayed on a status bar of a portable electronic device according to exemplary embodiments of the present invention.

FIG. 6B in images (a) and (b) illustrate symbols that may be used to display real-time battery consumption information of a portable electronic device according to exemplary embodiments of the present invention.

FIG. 6C in images (a) and (b) illustrate respectively different symbols used as battery consumption information and battery usage level information of a portable electronic device according to exemplary embodiments of the present invention.

FIG. 6D illustrates a diagram of notification information on a display of a portable electronic device according to exemplary embodiments of the present invention.

FIG. 7A and FIG. 7B are flowcharts illustrating methods for managing a battery for a portable electronic device according to exemplary embodiments of the present invention.

FIG. 8A illustrates a diagram of a screen on a display of a portable electronic device according to exemplary embodiments of the present invention.

FIG. 8B illustrates a diagram of a screen on a display of a portable electronic device according to exemplary embodiments of the present invention.

FIG. 8C illustrates a diagram of battery display guide information displayed on a display of a portable electronic device according to exemplary embodiments of the present invention.

FIG. 8D illustrates a diagram of a display screen of a portable electronic device according to exemplary embodiments of the present invention.

FIG. 8E illustrates a diagram of a display screen of a portable electronic device according to exemplary embodiments of the present invention.

FIG. 8F illustrates a diagram of a display screen of a portable electronic device according to exemplary embodiments of the present invention.

### DETAILED DESCRIPTION

The following description provides a comprehensive understanding of the apparatuses and systems of a portable electronic device having a battery management operation and methods for managing battery power consumption in portable electronic devices, apparatuses and systems. Accordingly, various changes, modifications, and equivalents of the methods, apparatuses, and systems described herein will be suggested to those of ordinary skill in the art. Also, descriptions of well-known operations and constructions as known to those skilled in the art may be omitted for increased clarity and conciseness.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Hereinafter, exemplary embodiments of portable electronic devices, apparatuses and systems having a battery management operation and methods for managing battery power consumption in portable electronic devices, apparatuses and systems will be described more fully with reference to the accompanying drawings, in which exemplary embodiments are illustrated. Terms as referred to in the following description are described in relation to operations, and as such, their understanding to one or skill in the art may vary according to users, operator's intention, or custom, for example. Accordingly, the meanings of terms herein are based on the entire contents of the present application, and should be interpreted as typically recognized by one skilled in the art when not specifically defined.

It will be understood that when an element is referred to as being “connected to” another element, it can be directly connected to the other element, or intervening elements may be present; and, as to wireless communication, may be interpreted as being wirelessly connected, such as a wireless connection between a portable electronic device and a base station or external server, for example.

Hereinafter, a portable electronic device may include, for example, a mobile communication terminal, handheld, portable or tablet computer or communication devices, or other apparatuses, having a battery management operation, will be described in more detail with reference to the drawings, and should not be construed in a limiting sense. Also, the portable electronic devices, apparatuses and systems and the units, modules and components of the portable electronic devices, apparatuses and systems herein described, include hardware and software, and can also include firmware, to perform various operations of the portable electronic devices, apparatuses and systems including those having a battery management operation, including those described herein, as may be known to one of skill in the art. As such, portable electronic device as used herein should not be construed in a limiting sense and may include the above and other apparatuses having a battery management operation.

Also, a portable electronic device may include, for example, any of various devices or structures used for wireless or wired communication having a battery management operation and can be wired or wireless connected to a base station, server or network, and may include another portable electronic device, and also may include hardware, firmware, or software to perform various battery management operations, including those described herein, as may be known to one of skill in the art.

Hereinafter, a portable electronic device, such as including, for example, a mobile terminal, a mobile communication terminal, handheld, portable or tablet computer or communication devices, or other apparatuses, and methods for a battery management operation will be described in more detail with reference to the drawings.

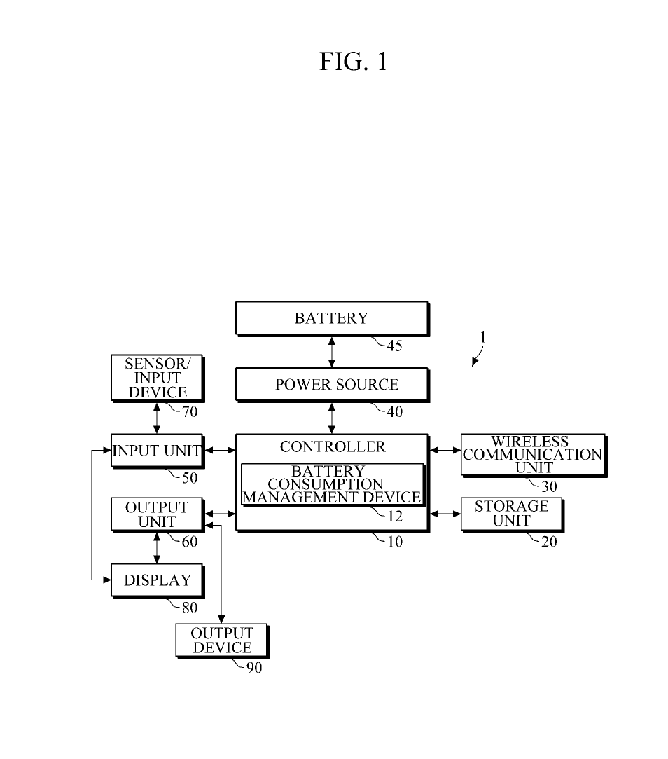

FIG. 1 illustrates a block diagram of a portable electronic device 1 having a battery management operation according to exemplary embodiments of the present invention. The portable electronic device 1 of FIG. 1 may be an electronic device using a battery having limited power capacity as a main power source. Also, the portable electronic device 1 may be an electronic device (e.g., a smart phone, a tablet computer, or a laptop computer) whose battery consumption greatly varies according to an operation state, but is not limited thereto and, therefore, should not be construed in a limiting sense. For example, the portable electronic device 1 may be a cellular phone, a MPEG audio layer-3 (MP3) player, a digital camera, a portable multimedia player (PMP), a navigation device, a portable game player, an electronic dictionary, an electronic-book (E-book) reader, or a digital multimedia broadcasting receiver.

Referring to FIG. 1, the portable electronic device 1 may include a controller 10, such as a processor, having a battery consumption management device 12, a storage unit 20, a wireless communication unit 30, a power source 40, an input unit 50, and an output unit 60. Here, the battery consumption management device 12 is a device, module component or a unit including or used in conjunction with hardware or firmware of the portable electronic device 1 to execute the battery management operation of the portable electronic device 1 and, as such, should not be construed in a limiting sense.

The portable electronic device 1 including controller 10, the battery consumption management device 12, the storage unit 20, the wireless communication unit 30, the power source 40, then input unit 50, and the output unit 60, and other modules, components, units or devices of the portable electronic device 1 are associated with and may include any of various memory or storage media for storing software, program instructions, data files, data structures, and the like, and are associated with and may also include any of various processors, computers or application specific integrated circuits (ASICs) for example, to implement various operations for having a battery management operation, such as for the portable electronic device 1, as described herein.

And although the controller 10, battery consumption management device 12, the storage unit 20, the wireless communication unit 30, the power source 40, then input unit 50, and the output unit 60, and other modules, components, units or devices of the portable electronic device 1 may be described as separate units, processors, memories, modules or components, aspects are not limited thereto such that each of the units, processors, memories, modules or components may be combined with any one or more units, processors, memories, modules or components, for example, and should therefore should not be construed in a limiting sense.

Also, the controller 10, the battery consumption management device 12, the storage unit 20, the wireless communication unit 30, the power source 40, then input unit 50, and then output unit 60, and other modules, components, units or devices of the portable electronic device 1 may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

In addition, the portable electronic device 1 shown in FIG. 1 is a device having a wireless communication operation and typically includes at least one sensor/input device 70, for example. Also, the portable electronic device 1 may not include one or more modules shown in FIG. 1. Also, the portable electronic device 1 may further include other modules to perform routine or specific operations of the portable electronic device 1. Added modules may vary according to the kind or operation of the portable electronic device 1. For example, the portable electronic device 1 may further include a sensor module, such as constituting or including the sensor/input device 70 (e.g., a gravity sensor, a proximity sensor, and/or an acceleration sensor), a vibration generation module, a GPS module, and a broadcasting receiving module.

The controller 10 may serve general management, processing, and control required for operations of the portable electronic device 1. For example, the controller 10 may perform control and signal processing operations (e.g., data communication and telephone conversation) so that the portable electronic device 1 can communicate with a server or another electronic device. Also, the controller 10 may perform control and signal processing operations (e.g., game playing and multimedia reproduction) to execute one or more operations, modules or one or more applications in the portable electronic device 1. Furthermore, the controller 10 may perform a processing operation in response to a user input signal or request signal received from the input unit 50, or control the output unit 60, to output the results of the processing of the input signal or the general execution results of the controller 10.

In addition, the controller 10 may perform control operations so that the portable electronic device 1 can support the battery management operation, according to exemplary embodiments. To enable the battery management operation, the controller 10 may calculate or determine real-time power consumption of the portable electronic device 1 periodically and/or at a time or times set by a user of the portable electronic device 1. And the controller 10 may determine a power consumption status based on the calculated or determined real-time power consumption. Also, the controller 10 may output real-time battery consumption information corresponding to the determined power consumption status through the output unit 60, such as including a display 80. As described further herein, the real-time battery consumption information may be displayed by one status level selected from a plurality of status levels distinguished from one another by a color or a plurality of colors, for example, according to exemplary embodiments.

In this regard, the controller 10 may include the battery consumption management device 12 as a unit configured to perform the battery management operation. The battery consumption management device 12 may output various information required, or helpful, for managing the battery 45, such as may be included in or a part of the power source 40, through the output unit 60 in response to a user input signal or request signal received from the input unit 50. For instance, when an input (e.g., a touch input received when a user touches the real-time battery consumption information displayed on the display 80) is sensed through the input unit 50, the battery consumption management device 12 may output notification information regarding the real-time battery consumption information through the output unit 60, such as to be displayed on the display 80, in response to the user input signal.

Also, when a request signal is sensed through the input unit 50 to request a present or current status of the output real-time battery consumption information, the battery consumption management device 12 may output consumption present-status information (e.g., a list of power consumptions of respective battery consumption elements) regarding each of the battery consumption elements of the portable electronic device 1 through the output unit 60, such as to be displayed on the display 80, in response to the request signal.

The storage unit 20 may be used to store applied programs and data required for operations of the portable electronic device 1. More specifically, the storage unit 20 may store various kinds of applied programs (e.g., an operating system (OS) program, a plurality of operation module programs, and one or more application programs) for enabling processing and control operations of the controller 10. Also, the storage unit 20 may store data or information, such as mail, texts, images, moving images, documents, music, phone numbers, telephone conversation recordings, and messages. Although the type of storage unit is not specifically limited to a particular type of storage, the storage unit 20 may include a RAM, and may also include an embedded and/or external flash memory, a magnetic disk memory, and a read only memory (ROM), for example.

In addition, the storage unit 20 may store real-time battery consumption information generated by the battery consumption management device 12 and/or a present status of power consumption of each of the battery consumption elements of the portable electronic device 1, according to exemplary embodiments. Also, the storage unit 20 may include a current consumption database (DB) in which a reference current consumption of each of the battery consumption elements of the portable electronic device 1 is stored. The current consumption DB will be further described herein. Also, the storage unit 20 may store information, such as user setup information related to battery consumption management, an updating period of real-time battery consumption information, a method of displaying real-time battery consumption information, and a range of levels of real-time battery consumption information, for example.

The wireless communication unit 30 may transmit and receive electromagnetic waves (EMW), and communicate with a wireless communication network and/or another electronic device. The wireless communication unit 30 may perform communication operations according to at least one wireless communication protocol, but the communication operations of the wireless communication unit 30 are not limited by the kind or number of wireless communication protocols.

The power source 40 may supply power required for the operation of the portable electronic device 1 to each of components of the portable electronic device 1. The portable electronic device 1 may include the battery 45 as the power source 40. The battery 45 may be attached to or detached from the portable electronic device 1, or integrally mounted on the portable electronic device 1. However, it is apparent to one skilled in the art that the portable electronic device 1 may include a module configured to receive power from an external power system, as well.

The input unit 50 may be used to input user data, inputs, commands, and request signals to the portable electronic device 1, while the output unit 60 may be used to output data, information, and signals processed by the portable electronic device 1. In this regard, the input unit 50 may include one or more sensor/input devices 70, such as a camera configured to input image/video signals, a microphone configured to input voices or sound, a key pad configured to enable a user to input data or commands to the portable electronic device 1, a dome switch, a button, a jog wheel, or a touch pad. Also, the output unit 60 may include or operate in conjunction with the display 80 configured to output image signals or video signals, or an audio output device 90 (e.g., a speaker and/or an ear jack) configured to output audio signals, for example.

The portable electronic device 1 may include a touch screen, such as may be a part of the sensor/input device 70 or a part of the display 80. The touch screen may be an input/output (I/O) device configured to enable interaction between a user and the portable electronic device 1. The touch screen may implement both the operation of a touch pad, which is a component of the input unit 50, and the operation of a display, which is a component of the output unit 60. The touch screen may have a stack structure of the touch pad serving as an input unit and the display serving as an output unit, or a structure in which the touch pad and the display are integrally formed. The user may directly touch the touch screen or indirectly touch the touch screen using a stylus pen, and input commands or information to the portable electronic device 1. Also, the portable electronic device 1 may output texts, images, and/or moving images through the touch screen to the user.

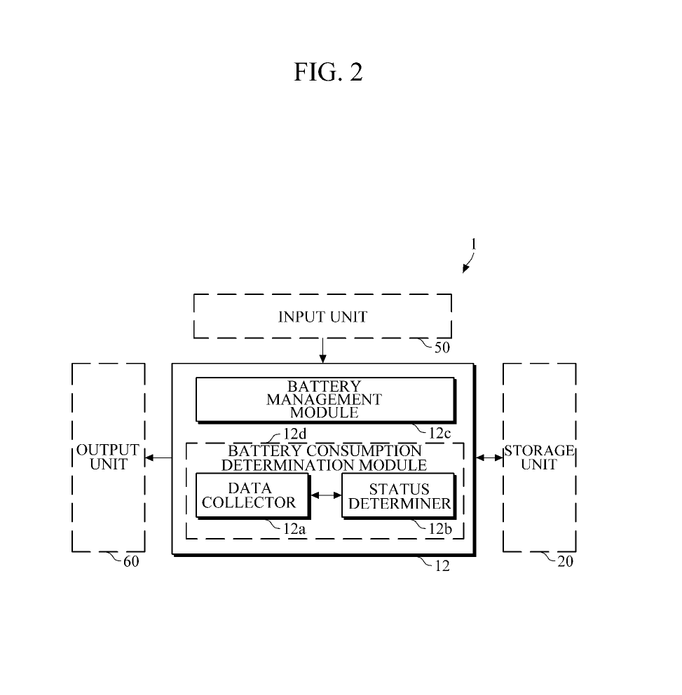

FIG. 2 illustrates a block diagram of a battery consumption management device 12 of the portable electronic device 1 of FIG. 1, according to exemplary embodiments of the present invention. As described herein, the battery consumption management device 12 may be a unit, module or a device configured to provide battery management operation of the portable electronic device 1. Referring to FIG. 2, the battery consumption management device 12 may include a battery consumption determination module 12d, including a data collector 12a and a status determiner 12b, and may also include a battery management module 12c. The battery consumption determination module 12d may include the data collector 12a and the status determiner 12b, but is not limited thereto, and may include other modules, components, units or devices related to the battery management operation.

Also, respective elements of the battery consumption determination module 12d, such as the data collector 12a and the status determiner 12b shown in FIG. 2 may be logically classified according to corresponding operations. Further, the data collector 12a and the status determiner 12b and other elements of the battery consumption determination module 12d may be integrally integrated into one module, unit, device or component. Elements of the battery consumption determination module 12d, such as the data collector 12a and the status determiner 12b may form respectively different modules components, units or devices, for example, and should not be construed in a limiting sense.

The battery consumption determination module 12d, including the data collector 12a and the status determiner 12b may calculate or determine the amount of power currently consumed by the portable electronic device 1 (i.e., real-time power consumption, for example) and determine a power consumption status based on the real-time power consumption, according to exemplary embodiments. The power consumption status may indicate the extent of power currently consumed by the portable electronic device 1. Since the portable electronic device 1 may include various kinds of hardware, firmware and software, power consumption of the portable electronic device 1 may correspond to the sum of power consumptions of one or more of the hardware, firmware and software of the portable electronic device 1, for example.

Battery consumption of the portable electronic device 1 may correspond to the sum of power consumptions of not all of the hardware, firmware and software but some modules, component, units or devices of the portable electronic device 1 when it may be difficult to calculate or determine real-time power consumptions of all, or substantially all, of the hardware, firmware and software as, for example, due to various physical or other limitations as may be present, or when it is intended to conveniently calculate or determine an estimate of or a general approximation of the real-time power consumption of the portable electronic device 1. In the latter case, when the portable electronic device 1 is turned on, hardware, firmware or software configured to always, or most of the time, consume constant, or relatively constant, power and/or some pieces of hardware, firmware or software configured to consume relatively little power, may be excluded from the calculation or determination of the real-time power consumption, according to exemplary embodiments.

The power consumption status of the portable electronic device 1 may be defined or expressed in various ways, and should not be construed in a limiting sense. For example, the power consumption status may be defined or expressed by an absolute numerical value of the calculated or determined power consumption of the portable electronic device 1. The power consumption status may be defined or expressed by a relative numerical value.

Also, the power consumption status may be defined or expressed using a relative value obtained by a comparison of the current power consumption with the maximum power consumption of the one or more battery consumption elements of the portable electronic device 1. The term ‘maximum power consumption’ is the consumed amount of power when all, or substantially all, of the one or more battery consumption elements of a portable electronic device, such as portable electronic device 1, are simultaneously, or at about the same time, operated. And the value of the maximum power consumption for a portable electronic device 1 may be previously obtained, such as by using a test, for example.

The power consumption status may be defined as a ratio (or a percentage) of a difference between the current power consumption and the minimum power consumption to a difference between the maximum power consumption and the minimum power consumption, or defined as an arbitrary consumption mark between 0 and 100. In this case, the power consumption status may have a relative numerical value between 0.0 and 1.0 (or a percentage between 0% and 100%), for example.

In addition, the power consumption status may be defined using the foregoing numerical value and/or defined as sections, levels or grades as status levels. The sections, levels or grades of the power consumption status may be classified based on an absolute numerical value or relative numerical value of the power consumption. For example, status levels may be based on or correspond to a range of relative numerical values, such as, for example a range of 0.0 to 1.0, between the minimum battery consumption (a relative numerical value of 0) of the one or more battery consumption elements or of the portable electronic device 1 and the maximum battery consumption of the one or more battery consumption elements or of the portable electronic device 1 (a relative numerical value of 1).

And the status levels may be divided into n sections, or n levels or n grades (as, for example, n is an integer equal to or more than 3), and the power consumption status of the one or more battery consumption elements or of the portable electronic device 1 may correspond to the status levels of the power consumption as may be defined as a corresponding one section, level or grade of the n sections, levels or grades.

When the power consumption status is divided into four sections, levels or grades, the respective sections, levels or grades may be defined on the basis of, for example, Table 1. Also, as shown in Table 1, respective status levels of the respective sections, levels or grades corresponding to battery consumptions may be distinguished from one another by color and/or output, for example. As battery consumption increases and comes closer to the maximum power consumption, the level of battery consumption may be displayed in a red-based color, while as battery consumption decreases and comes closer to the minimum power consumption, the level of battery consumption may be displayed in a green (or blue)-based color, for example. However, the exemplary embodiments are not limited to classifying the levels according to color and/or output, and should not be construed in a limiting sense.

TABLE 1

| | | Power | | |
|---|---|---|---|---|
| | | consumption | | |
| | Power | (Percentage (%) & | | |
| | consumption | Relative | | |
| Status: | (Absolute | Numerical Value | Display | |
| Level | value) | (0.0 to 1.0)) | color | Meaning |
| 1 | Pₘᵢₙ to | 0% to 25% | Green | Low power |
| | 0.25Pₘₐₓ | 0.0 to 0.25 | | consumption |
| 2 | 0.25Pₘₐₓ to | 25% to 50% | Yellow | Middle power |
| | 0.50Pₘₐₓ | 0.25 to 0.50 | | consumption |
| 3 | 0.50Pₘₐₓ to | 50% to 75% | Orange | High power |
| | 0.75Pₘₐₓ | 0.50 to 0.75 | | consumption |
| 4 | 0.75Pₘₐₓ to | 75% to 100% | Red | Very high power |
| | 1.00Pₘₐₓ | 0.75 to 1.0 | | consumption |

Here, Pₘᵢₙ refers to the minimum power consumption, and Pₘₐₓ refers to the maximum power consumption of a portable electronic device, such as portable electronic device 1.

As described above, the battery consumption determination module 12d may include the data collector 12a and the status determiner 12b configured to determine the power consumption status of the portable electronic device 1. The data collector 12a may collect use data from each of several elements, modules, units, components or devices of the portable electronic device 1 that typically may affect battery consumption (hereinafter, referred to as ‘battery consumption element’ or ‘battery consumption elements’), and obtain the use data for these battery consumption elements. The use data may provide information indicating whether each of the battery consumption elements of the portable electronic device 1 consumes power and/or how much power each of the battery consumption elements consumes. Also, the status determiner 12b may determine a power consumption status of the portable electronic device 1, or for one or more battery consumption elements, using the use data obtained by the data collector 12a.

The battery consumption elements whose use data are collected by the data collector 12a may include hardware or firmware included in the portable electronic device 1 and/or one or more applied programs configured to manage and control an operation or operations of the hardware or firmware. For example, the battery consumption elements of the portable electronic device 1, which provide the use data, may include not only hardware, such as a CPU included in the portable electronic device 1, a memory (e.g., a RAM or a flash memory), a wireless communication module (e.g., a mobile communication module, a WiFi module, a Bluetooth module, or a near field communication (NFC) module), a GPS, various sensors, a display, and an audio output device (e.g., a speaker or an ear jack), but also firmware or software, such as a CPU manager, a memory manager, a network provider, a GPS provider, a notification manager, a media player, a sensor provider, a battery manager, a display manager, an audio manager, and an application.

The types of use data collected by the data collector 12a are not specifically limited, and the use data may vary according to the kinds or characteristics of the battery consumption elements of the portable electronic device 1. For example, the data collector 12a may receive a CPU occupancy of an application as use data from the CPU and/or the CPU manager of the controller 10, and receive the used amount of the RAM as use data from the RAM and/or the memory manager, receive a network connection status (indicating whether or not each wireless communication module is executed and whether each wireless communication module is in a data transceiving state or in a standby state when each wireless communication module is executed, for example) as use data from the wireless communication module and/or the network provider, receive the use or disuse of a sensor module as use data from the sensor and/or the sensor provider, and receive an on or off state of the display as use data from the display and/or the display manager.

The status determiner 12b may determine a power consumption status of the portable electronic device 1 using the obtained use data, such as from the data collector 12a. Methods for determining, by the status determiner 12b, the power consumption status using the use data may depend on the characteristics or kinds of use data. For example, when it is possible to determine the power consumption of the corresponding one or more battery consumption elements using only the use data, the status determiner 12b may determine the power consumption status by simply adding the power consumptions of the one or more battery consumption elements.

Alternatively, according to exemplary embodiments, when the use data indicates an on/off state, use/disuse state, or execution/non-execution state (hereinafter, referred to also as the ‘on/off state’) of the corresponding battery consumption element, the status determiner 12b may determine the power consumption status with reference to a current consumption (or power consumption) DB included in the storage unit 20. A reference current consumption measured or determined when the corresponding battery consumption element is in an on state (or use state or execution state) may be stored in the current consumption DB. The ‘reference current consumption’, which is the amount of current consumed when the corresponding battery consumption element is in an on state, may be obtained by previously collecting data via a test conducted on the portable electronic device 1.

Also, a difference between an on-state current consumption of the corresponding battery consumption element and an off-state (or disuse-state or non-execution-state) current consumption of the corresponding battery consumption element may be stored in the current consumption DB. In this case, the status determiner 12b may determine which battery consumption elements of the portable electronic device 1 are presently in an on state based on the use data collected by the data collector 12a, add up the on-state/off state current consumption differences of the respective determined on-state battery consumption elements, and determine the power consumption status of the one or more battery consumption elements. If the amount of current consumed when at least two battery consumption elements are simultaneously, or at about the same time, in an on state is less than the sum of the amounts of current consumed when the at least two battery consumption elements are discretely in an on state, the current consumption DB may also include a current consumption of a combination of the on-state battery consumption elements, for example.

The current consumption DB may include a previously obtained on-state current consumption of each of the one or more battery consumption elements or may include a difference between the on-state current consumption of each of the battery consumption elements and an off-state current consumption corresponding to each of the battery consumption elements as a reference current consumption, for example. The current consumption of each of the battery consumption elements may include the following data, but is not limited thereto and, therefore, should not be construed in a limiting sense.

For example, the current consumption DB may include a difference in current amount between the on and off states of a backlight of the display, the on and off states of a wireless local area network (LAN), a difference in current amount between the on and off states of a global positioning system (GPS), a difference in current amount between the on and off states of one mobile communication module or a plurality of (e.g., 3^{rd}- and 4^{th}-generation) mobile communication modules, a difference in current amount between the on and off states of a Bluetooth device, a difference in current amount between the on and off states of an ear jack, a difference in current amount between the on and off states of various sensors, and a difference in current amount between an execution (on) state and non-execution (off) state of a specific application (e.g., an audio phone call, a video phone call, vocal output, multimedia reproduction, synchronization with a server, and updating of a screen).

Referring to FIG. 2, the battery management module 12c may generate real-time battery consumption information corresponding to the power consumption status obtained as the determination result of the battery consumption determination module 12d, as described herein, and output the real-time battery consumption information through the output unit 60. When the power consumption status is defined by a numerical value, the battery management module 12c may output the real-time battery consumption information using a numerical value, for example. When the power consumption status is defined by any one of a plurality of status levels, the battery management module 12c may output the real-time battery consumption information as a status level, for example.

Also, the real-time battery consumption information may further include a battery power remaining time of the portable electronic device 1. The battery power remaining time refers to or is expressed as a time duration of battery power remaining to operate the portable electronic device 1 for which the portable electronic device 1 may be used in the current power consumption status going forward in time, based on a battery usage level. Also, the real-time battery consumption information may further include a battery usage level of the portable electronic device 1, as, for example, a ratio of the currently remaining power amount to the power amount of the completely charged battery.

The real-time battery consumption information may be required to notify a user of the extent of power currently consumed by the portable electronic device 1. A format for displaying the real-time battery consumption information is not limited to a particular format or formats. For example, the battery management module 12c may display the real-time battery consumption information on the display 80 of the portable electronic device 1 using a visual format (e.g., text or graphics) and/or output the real-time battery consumption information using an auditory format (e.g., warning sound or voice), such as from a speaker associated with the output unit 60. In an example, when the real-time battery consumption information is output at a status level, the battery management module 12c may distinguish the plurality of status levels from one another using reference images (or reference symbols), and display the reference images (or reference symbols) on the display 80 so that each of the status levels can be perceived intuitively by a user of the portable electronic device 1. As described in Table 1, the battery management module 12c may display a status level in a green based color, a yellow based color or any of other various colors or color combinations, such as a blue-based color on the display 80 when the power consumption status indicates a relatively low to middle range power consumption, and display the status level in a red-based color on the display when the power consumption status indicates a relatively high power consumption, for example. Also, for example, the value of the percentage or the absolute value of the power consumption may also be expressed, indicated or displayed in a corresponding color for ease of recognition as, for example, a green, yellow, orange, red or blue percentage or a green, yellow, orange, red or blue absolute value, according to exemplary embodiments.

The battery management module 12c may output various pieces of information required for battery consumption management through the output unit 60 in response to a user's inputs transmitted from the input unit 50. For example, when a user's input signal for the real-time battery consumption information that is displayed on the display 80 or vocally output from the user is received through a microphone associated with the input unit 50, the battery management module 12c may display notification information regarding the displayed or output real-time battery consumption information on the display 80. Also, when a user's request signal to request the present status of the output real-time battery consumption information is received through the input unit 50, the battery management module 12c may display information (e.g., a list of power consumptions of one or more battery consumption elements) regarding the battery consumption present-status of one or more or each of the battery consumption elements of the portable electronic device 1 on the display 80 in response to the user's request signal.

Exemplary embodiments may also include those in which the battery consumption management device 12 is embodied on an OS operating on the controller 10 of the portable electronic device 1. In general, the portable electronic device 1 may broadly include a hardware hierarchy, a platform configured to process and transmit signals input by the hardware hierarchy, and an applied program hierarchy including various applied programs that are driven based on the platform. Also, for example, the platform may be divided into an Android™ platform, a Windows mobile platform, and an iOS platform according to the OS of the portable electronic device 1. Although the respective platforms may have somewhat different structures, their basic operations are relatively the same or similar.

In this regard, the Android platform may include, for example, a Linux Kernel hierarchy, a library hierarchy, and a framework hierarchy. And the windows mobile platform may include, for example, a Windows core hierarchy and an interface hierarchy. Also, the iOS platform may include, for example a core OS hierarchy, a core service hierarchy, a media hierarchy, and a cocoa touch hierarchy. In these examples, each hierarchy may be expressed as a block. Also, the framework hierarchy of the Android platform or each of hierarchies of other platforms, similarly corresponding thereto, may be defined or expressed as a software block.

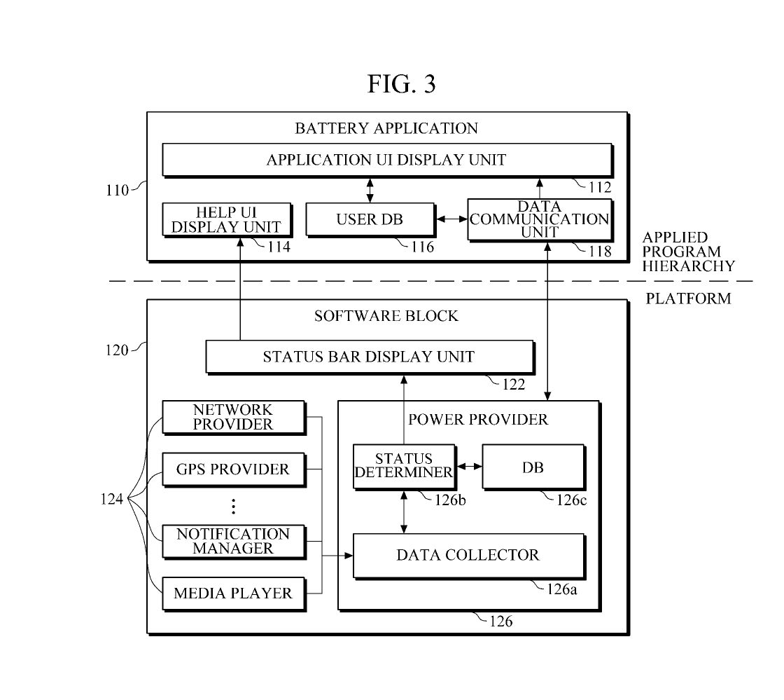

FIG. 3 illustrates a block diagram of the battery consumption management device 12 of FIG. 2 according to exemplary embodiments of the present invention, which may be formed on an OS of the portable electronic device 1. Although FIG. 3 shows the battery consumption management device 12 embodied on an Android OS, such as operating on the controller 10, the exemplary embodiments are not so limited and, therefore, should not be construed in a limiting sense. In FIG. 3, the battery consumption management device 12 of FIG. 2 is embodied by a battery application 110 of an applied program hierarchy (or block), and a power provider 126 of a software block 120. As stated above, the applied program hierarchy may correspond to an application hierarchy of the Android OS, while the software block 120 may correspond to the framework hierarchy of the Android OS, for example.

In that the battery consumption management device 12 has been described in relation to FIG.1 and FIG. 2, the battery consumption management device 12 is further described so as to avoid redundancy. And, thus, a detailed description of the battery consumption management device 12 will be understood with reference to the description herein in relation to that offered for FIG. 1 and FIG. 2.

Continuing with reference to FIG. 3, the power provider 126 may determine a power consumption status based on real-time power consumption of a portable electronic device 1, generate real-time battery consumption information corresponding to the power consumption status, which is the determination result, and transmit the real-time battery consumption information to a status bar display unit 122 of the portable electronic device 1. To determine the real-time battery consumption information, the power provider 126 may include a data collector 126a and a status determiner 126b. The data collector 126a and the status determiner 126b may be operationally the same as, or similar to, the data collector 12a and the status determiner 12b, respectively, which constitute the battery consumption determination module 12d of FIG. 2.

The data collector 126a may serve to collect use data from other modules 124 disposed in a software block 120, for example, a network provider, a GPS provider, a notification manager, and a media player, for example. Also, the collected use data may be transmitted to the status determiner 126b. The status determiner 126b may give a command to collect the use data to the data collector 126a at preset or reference time periods or at time periods set by a user, determine a power consumption status based on the use data collected by the data collector 126a, and determine or quantitate the power consumption status of the one or more battery consumption elements or of the portable electronic device 1, for example.

The determination results of the status determiner 126b may be stored in a DB 126c and transmitted to the status bar display unit 122 to display the determination results on the display 80 of the portable electronic device 1. The DB 126c may store real-time battery consumption information, which is the determination result of the status determiner 126b, as described. Also, the DB 126c may store data (e.g., a current consumption of each of the battery consumption elements) as may be required for the status determiner 126b to generate the real-time battery consumption information based on the use data of the one or more battery consumption elements or of the portable electronic device 1, for example.

The status bar display unit 122 may be a module provided in the software block 120 (e.g., an Android framework hierarchy) and operate to display various pieces of status information of the portable electronic device 1 (e.g., a smart phone or a tablet computer, etc.) on a status bar of the display 80 of the portable electronic device 1. For example, the status bar may be a region of the display 80 configured to display status information of the portable electronic device 1. The status bar may correspond to a status display region. The status information displayed on the status bar may include information on a battery usage level, WiFi, GPS, a network, and signal intensity, or other information. The status bar may be referred to as a notification bar. And, the status bar display unit 122 may also be referred to as a notification bar display unit, for example.

The battery application 110 may be an applied program configured to enable a user to manage the use of the battery 45 of the portable electronic device 1. The battery application 110 may display information related with the use of the battery 45, which includes the real-time battery consumption information, on the display 80, and output a user interface screen to the display 80. The user interface screen may enable a user to input various data required to manage the use of the battery 45 of the portable electronic device 1.

Also, the battery application 110 may not only store user setup values but also data required to execute applications by the controller 10 of the portable electronic device 1. The battery application 110 may transmit and receive various data and information to and from the framework hierarchy of the software block 120 including the power provider 126 and the status bar display unit 122. And, in this regard, the battery application 110 may have various configurations, according to exemplary embodiments. For example, referring to FIG. 3, the battery application 110 may include an application user interface (UI) display unit 112, a help UI display unit 114, a user DB 116, and a data transmitter 118.

The application UI display unit 112 may be used to display information related with the use of the battery 45, and input user setup values required, or that are helpful, to manage the use of the battery 45 of the portable electronic device 1. The information related with the use of the battery 45 may include notification information regarding the real-time battery consumption information displayed in a status bar region, and status information regarding the real-time battery consumption information, for example. Also, the user setup values, as may be selected or set by a user of the portable electronic device 1, may include an updating period or updating periods to update the real-time battery consumption information, one or more methods or arrangements for displaying the real-time battery consumption information, and a range or ranges or a number of levels, sections or grades, as corresponding to status levels of the real-time battery consumption information, for example. Further, the input user setup values may be used for automatic stopping or continuing operation of one or more battery consumption elements of a portable electronic device without further user input, and the input user setup values may be set by a designer, programmer, manufacturer, and may be defaults, or may be set or input by a user.

When the input of the real-time battery consumption information displayed on the status bar display unit 122 is sensed, the help UI display unit 114 may operate to display notification information in response to the sensed input. Also, the user DB 116 may store data required for the UI display units 112 and 114 of the battery application 110, and also store the user setup values. Furthermore, a data transmitter of the battery application 110, such as data communication unit 118, may transmit the user setup values to the power provider 126, and receive battery use information and present states of the one or more battery consumption elements or of the portable electronic device 1 from the power provider 126.

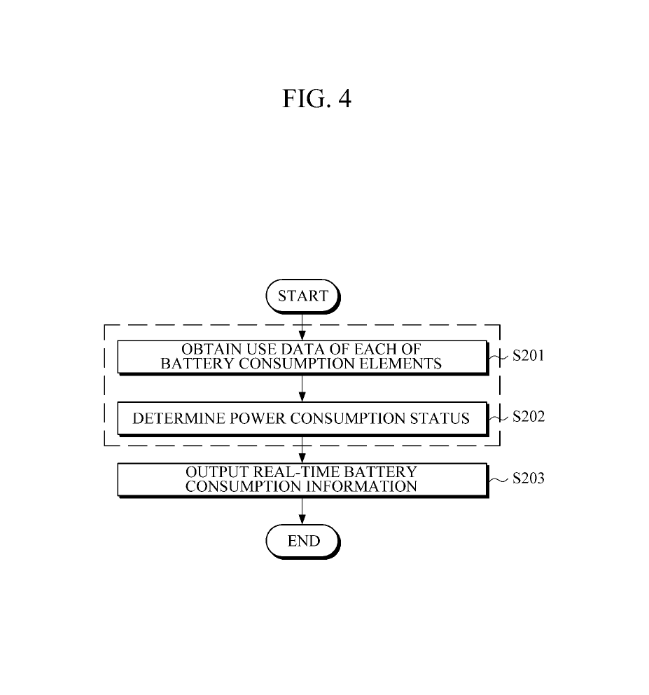

FIG. 4 is a flowchart illustrating methods for managing a battery for a portable electronic device according to exemplary embodiments of the present invention. The management methods shown in FIG. 4 may be embodied using the battery consumption management apparatus described herein with reference to FIG. 1 through FIG. 3. Accordingly, the battery management methods illustrated in FIG. 4 will be described in relation to and can be inferred from the description herein of the portable electronic device 1 of FIG. 1 to FIG. 3, according to exemplary embodiments; however, aspects are not limited thereto such that the battery management methods may be applied to other electronic devices.

Referring to FIG. 4, initially, a power consumption status may be determined based on real-time power consumption of the portable electronic device in operations S201 and S202. The power consumption status may indicate the extent of power currently consumed by the portable electronic device 1. The power consumption status may correspond to the sum of the power consumptions of all, substantially all, or some of various pieces of hardware, firmware and software included in the portable electronic device 1. Also, the power consumption status may be defined or expressed as a relative numerical value and/or a level, section or grade, such as may also be based on the absolute numerical value, maximum power consumption, and minimum power consumption of the calculated or determined power consumption of the one or more battery consumption elements or of the portable electronic device 1.

Continuing with reference to FIG. 4, for example, the process for determining the power consumption status may include a process of obtaining use data of each or one or more of the battery consumption elements included in the portable electronic device 1 at operation S201, and a process for determining the power consumption status using the use data as operation S202. The use data may be an example of information indicating whether each or one or more of the battery consumption elements of the portable electronic device 1 consumes power and/or how much power each or the corresponding one or more of the battery consumption elements consumes.

Also, the status determiner 12b may determine a power consumption status using the use data obtained by the data collector 12a. And the power consumption status may be determined by simply adding the power consumptions of the respective battery consumption elements of the portable electronic device 1. When use data indicates the on or off state of the corresponding battery consumption element, the power consumption status may be determined with reference to the included current consumption (or power consumption) DB, as described herein.

Again referring to FIG. 4, real-time battery consumption information corresponding to the power consumption status obtained as the determination result of operation S202 may be generated and output at operation S203. The real-time battery consumption information may be used to notify a user of the extent of power currently consumed by the portable electronic device 1, and indicated by numerical values or any one of a plurality of status levels. Also, the real-time battery consumption information may be disposed on the display 80 of the portable electronic device 1 using a visual format (e.g., text or graphics) and/or output through the audio output device 90 using an auditory format (e.g., warning sound or voice), such as through a speaker associated with the output unit 60. According to exemplary embodiments, a battery power remaining time and/or battery usage level information of the battery 45 of the portable electronic device 1 may be further displayed along with the real-time battery consumption information, for example.

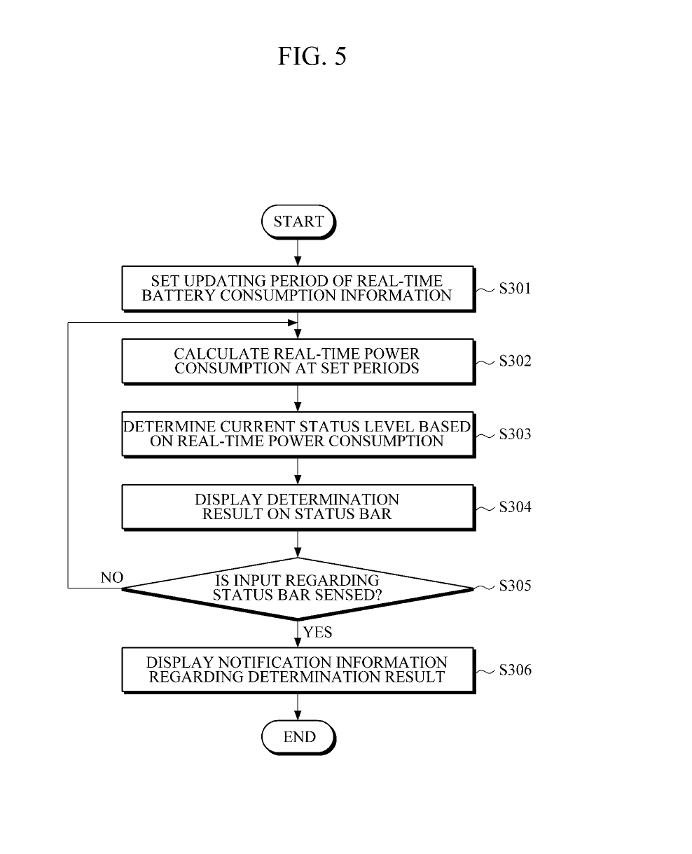

FIG. 5 is a flowchart illustrating methods for managing a battery for a portable electronic device according to exemplary embodiments of the present invention. The management method shown in FIG. 5 may be embodied using the battery consumption management apparatus described above with reference to FIGS. 1 through 3. Accordingly, the battery management methods illustrated in FIG. 5 will be described in relation to and can be inferred from the description herein of the portable electronic device 1 of FIG. 1 to FIG. 3, according to exemplary embodiments; however, aspects are not limited thereto such that the battery management methods may be applied to other electronic devices.

Referring to FIG. 5, initially, an updating time period of real-time battery consumption information of the one or more battery consumption elements or of the portable electronic device 1 may be set at operation S301. Although the updating time period may be preset as an internal value of the portable electronic device 1, it is assumed in the exemplary embodiments that a user may arbitrarily set the updating time period.

Accordingly, when the battery application does not permit the user to change the updating time period or when the updating time period is already set, even if the user is permitted to change the updating period, operation S301 may be omitted. A menu for setting the updating time period may be provided to the user in various ways. For example, after the user executes the battery application (refer to FIG. 3) of the portable electronic device 1, the user may select a user setup menu. Even if the battery application is not executed, the menu for setting the updating time period may be provided to the user after the user executes an environment setup menu of the portable electronic device 1, for example.

Thereafter, real-time power consumption of the portable electronic device 1 may be calculated or determined at the set updating time periods at operation S302, and a current or a present status level of the power consumption may be determined based on the calculated or determined real-time power consumption at operation S303. The status level of the power consumption may define a power consumption status and may indicate a present degree of power consumption of the portable electronic device 1.

In this regard, the status level may be one selected out of a plurality of status levels, which may respectively correspond to a plurality of subsections into which a range between a minimum power consumption status and a maximum power consumption status is divided. For example, the determination at operation S303 of the status level of the power consumption may include, for example, obtaining use data of each or the one or more of battery consumption elements included in the portable electronic device 1, and determining the status level based on real-time power consumption obtained using the use data and a current consumption DB, according to exemplary embodiments.

Referring again to FIG. 5, real-time battery consumption information corresponding to the status level obtained as the determination result in operation S303 may be displayed on a status display region, such as on the display 80 at operation S304. The status display region may correspond to a status bar or notification bar of a smart phone or a tablet computer, for example.

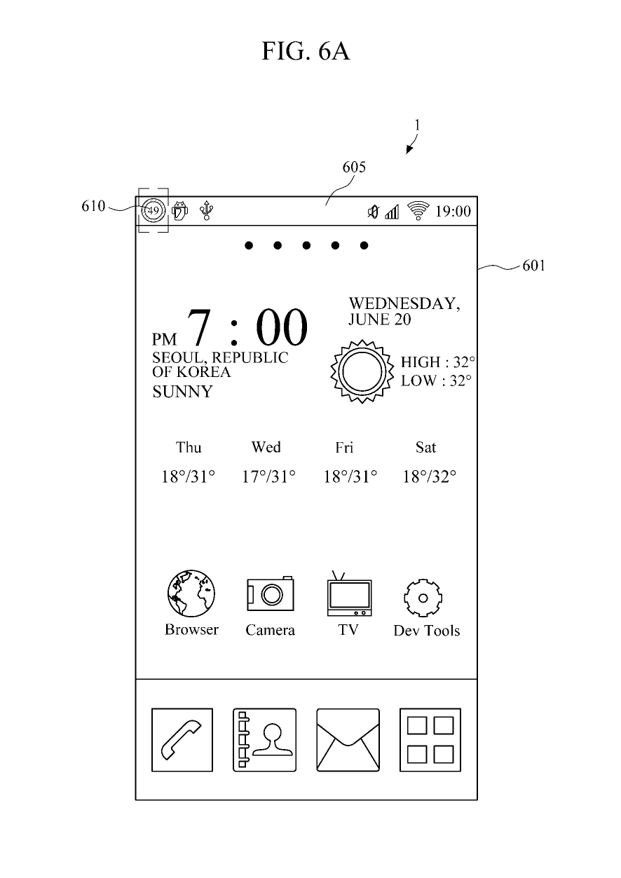

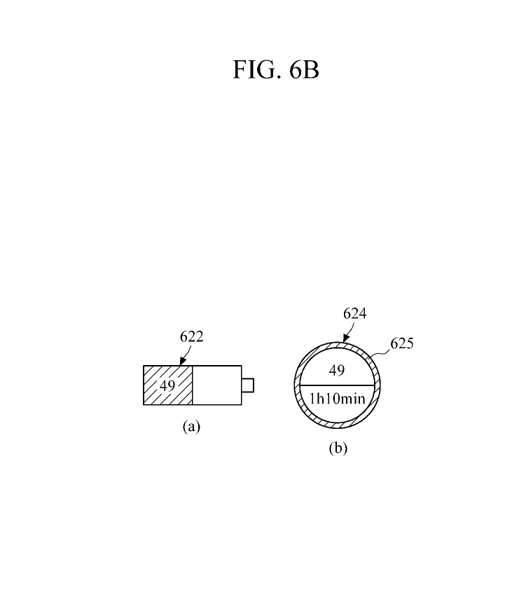

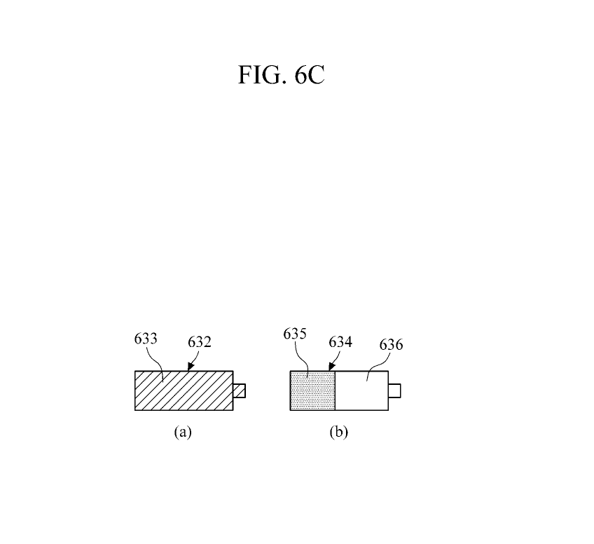

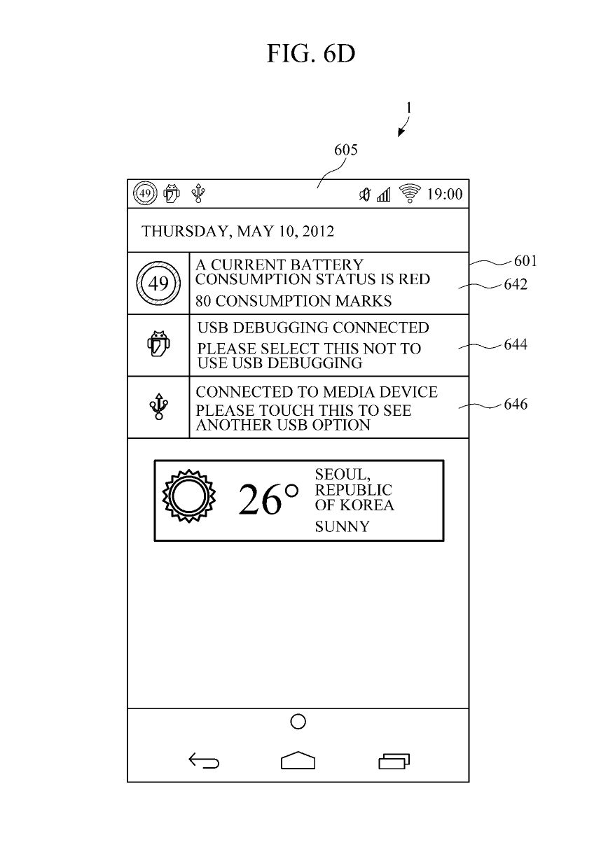

FIG. 6A is a diagram illustrating real-time battery consumption information on a status bar 605 associated with a display 601 of the portable electronic device 1 according to exemplary embodiments of the present invention. In FIG. 6A, the real-time battery consumption information is illustrated as a symbol 610 including a number described in a double circle surrounded with a dotted square is displayed on the status bar 605 (or a status display region disposed at an uppermost end of the display 601). In FIG. 6A, the number written in the symbol 610 in the hatched double circle refers to a battery usage level, and the real-time battery consumption information, that is, status levels may be distinguished from one another by color of a hatched region, for example, for ease of user reference or recognition.

However, the exemplary embodiments are not limited thereto, and the status levels, such as levels, sections or grades of the power consumption, may be distinguished from one another by color of another region of the symbol 610 or by changing the shape of the symbol 610, for example. In FIG. 6A, characters or images displayed on the display 601 of the portable electronic device 1 instead of the status display bar 605 show an example of a display screen of the portable electronic device 1, for example.

FIG. 6B in images (a) and (b) are diagrams of symbols that may be used to display real-time battery consumption information of the portable electronic device 1, according to exemplary embodiments of the present invention. Referring to a left image (a) of FIG. 6B, it can be seen that the overall shape of the symbol 622 is similar to that of a dry cell battery. Also, in right image (b) of FIG. 6B, a number described in symbol 624 of the dry cell battery and the size of a hatched region 625 of the dry cell battery refer to a battery usage level. And in right image (b) of FIG. 6B, the real-time battery consumption information may be displayed in the color of the battery usage level, such as in the color of the hatched region 625, for ease of user reference or recognition. Also, referring to a right image (b) of FIG. 6B, the overall shape of the symbol 624 and a region for displaying color indicating the real-time battery consumption information are similar to a shape of the symbol 610 in FIG. 6A. However, in symbol 624 of image (b) of FIG. 6B, it can be seen that a battery power remaining time (1 h 10 min) is displayed in the symbol 624 along with the real-time battery consumption information, unlike the information displayed in the symbol 610 in FIG. 6A, for example.

Also, according to exemplary embodiments, battery consumption information and battery usage level information may be displayed using respectively different symbols. In this case, a symbol for displaying the battery consumption information and a symbol for displaying the battery usage level information may be the same, similar or different from each other.

FIG. 6C in images (a) and (b) illustrate respectively different symbols used as battery consumption information and battery usage level information of a portable electronic device according to exemplary embodiments of the present invention. FIG. 6C illustrates where both the battery consumption information and battery usage level information are displayed using symbols in the shape of dry cell batteries, symbol 632 in image (a) of FIG. 6C and symbol 634 in image (b) of FIG. 6C, both being in the shape of dry battery cells.

In the dry cell battery symbol 632 in image (a) of FIG. 6C, the battery consumption information may be distinguished from the battery usage level information by a different color in the region 633 of the symbol 632 from the battery usage level information, as in the left image (a) of FIG. 6C. As shown in image (a) of FIG. 6C, the dry cell battery in symbol 632 may wholly or partially assume a color.

Also, as illustrated in the dry cell battery symbol 634 in image (b) of FIG. 6C, the battery usage level information may be indicated by the widths of a shadowed region 635 and a vacant region 636 of the dry cell battery shaped symbol 634, referring to the right image (b) of FIG. 6C, and/or may also be indicated by numbers or percentage (%) in the symbol 634, for example. Also, in a dry cell battery shaped symbol similar to the generally illustrated in images (a) and (b) of FIG. 6C, the battery usage level information may be displayed using a dry cell shape, while the battery consumption information may be displayed using figures with arbitrary shapes classified according to color. Also, the reverse case is possible, i.e. the battery usage level information may be displayed using figures with arbitrary shapes classified according to color, while the battery consumption information may be displayed using a dry cell shape, for example. The above-described exemplary embodiments may be effectively used when a display, such as display 80, of the portable electronic device 1 (e.g., a tablet computer) is relatively large, and a relatively large amount of information may be displayed on a status display region of the display 80, for example.

While exemplary embodiments have been described in which the real-time battery consumption information obtained as the determination result is displayed on the status display region (e.g., status bar) of the display 80 or the display 601 of the portable electronic device 1, the real-time battery consumption information may be displayed on another region of the display 80 or the display 601 and/or using another or different format.

For example, the real-time battery consumption information may be displayed in the form of a popup screen on the display 80 or on the display 601 and/or vocally output through the audio output device 90. Also, according to exemplary embodiments, methods for displaying the real-time battery consumption information may be set by a user of the portable electronic device 1. Displaying the real-time battery consumption information on the status bar, such as status bar 605 may be set as a default, and when other conditions are satisfied (e.g., when it is possible to display the status bar on the display 80 or on the display 601 and/or when another setup is provided by a user in advance), the real-time battery consumption information may be displayed in in various forms and combinations, such as in the form of a popup screen, or output using sound signals (e.g., voice or sound) such as on the audio output device 90, a pop-up of a color corresponding to the status level, a percentage or an absolute value of the battery power consumption in representation of a battery, or a percentage or an absolute value of the battery power consumption indicated in a color, such as red, yellow, orange, green or blue corresponding to a status level in representation of a battery, for example and should not be construed in a limiting sense.

Again, continuing with reference to FIG. 6A and to FIG. 5 and the methods therein illustrated for managing a battery for the portable electronic device 1, it may be determined whether there is an input regarding the status bar 605 at operation S305. The input regarding the status bar 605 may include a user's touch input regarding the real-time battery consumption information displayed on the status bar 605, or a user's gesture input (e.g., a touch on the status bar 605 displayed at an uppermost end of the display 601 in a downward direction) received to request detailed information regarding information displayed on the status bar 605, but the input or the manner of input is not limited in this regard. Accordingly, when the real-time battery consumption is displayed in the form of a popup screen on the display 601, or vocally output on the audio output device 90, instead of on the status bar 605, operation S305 may include determining whether there is a user's input regarding the popup screen or vocal output, according to exemplary embodiments.

When it is determined in operation S305 that there is no input regarding the status bar 605, the process returns and operations S301 and S302 may be performed again. In contrast, when it is determined in operation S305 that there is input regarding the status bar 605, notification information regarding each of the one or more symbols corresponding to the battery consumption indicated on the status bar 605 on which the determination results are displayed, may be displayed on the display 601 or the display 80 at operation S306.

FIG. 6D illustrates a diagram of notification information on the display 601 of the portable electronic device 1 according to exemplary embodiments of the present invention. Referring to FIG. 6D, it can be seen that among three pieces of notification information (i.e., real-time battery consumption information 642, universal serial bus (USB) debugging connection information 644, and information regarding connection to another device 646), a detailed description of the real-time battery consumption status is displayed as the notification information 642 on the uppermost row of the three pieces of information on the display 601. The detailed description of the real-time battery consumption status in the notification information 642 may include, for example, a color indicating the status level of the real-time battery consumption status and a basis (for example, a consumption mark) on which the real-time battery consumption status has the status level indicated by the corresponding color.

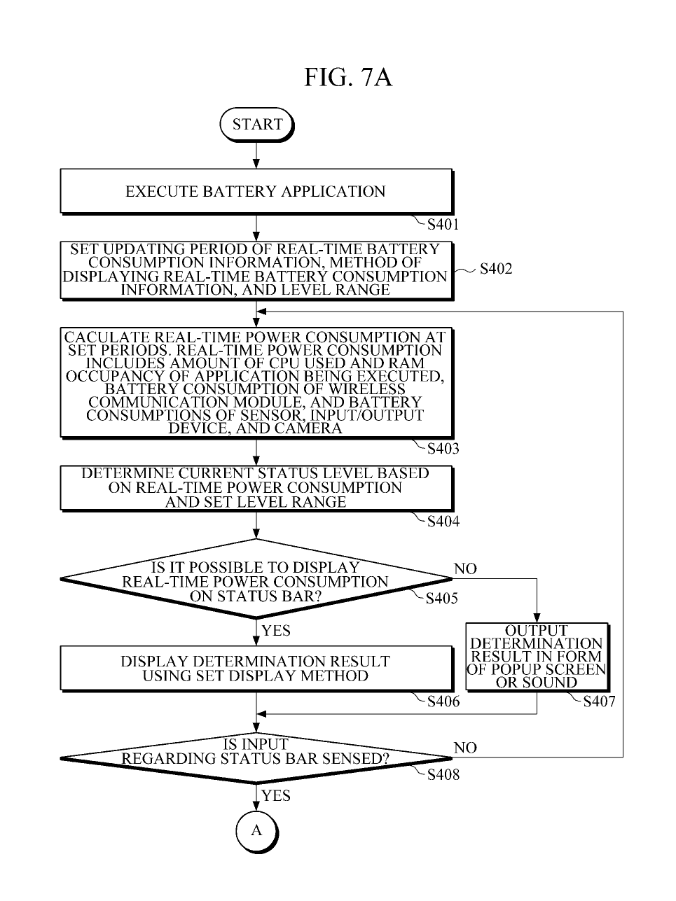

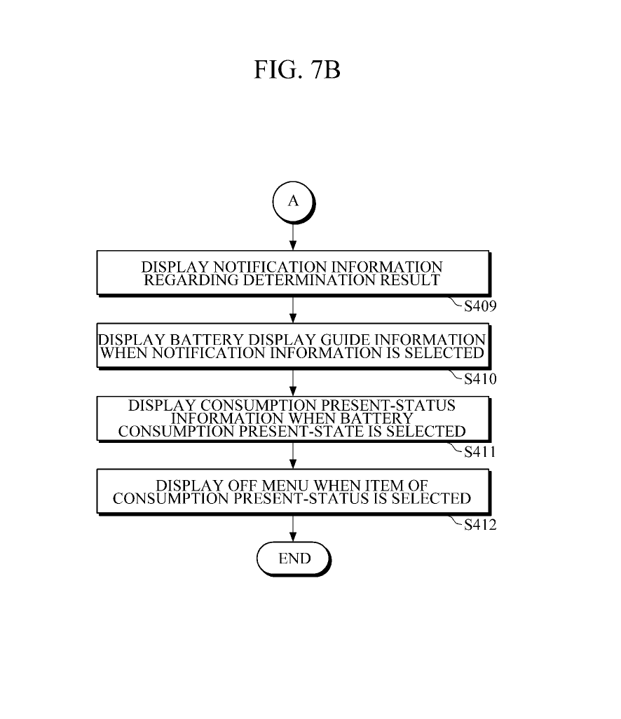

FIGS. 7A and 7B are flowcharts illustrating methods for managing a battery of a portable electronic device, according to exemplary embodiments of the present invention. Although the methods illustrated in FIGS. 7A and 7B are related exemplary embodiments, the methods illustrated in FIGS. 7A and 7B have been illustrated in two illustrations ease of understanding. The methods shown in FIGS. 7A and 7B may be embodied using the battery use management apparatus described herein with reference to FIG. 1 through FIG. 3; however, aspects need not be limited thereto such that the methods may be embodied using other electronic devices. Accordingly, the battery management methods illustrated in FIG. 7A and FIG. 7B will be described in relation to and can be inferred from the description herein of the portable electronic device 1 of FIG. 1 to FIG. 3, according to exemplary embodiments; however, aspects need not be limited thereto such that the methods may be applied to other electronic devices

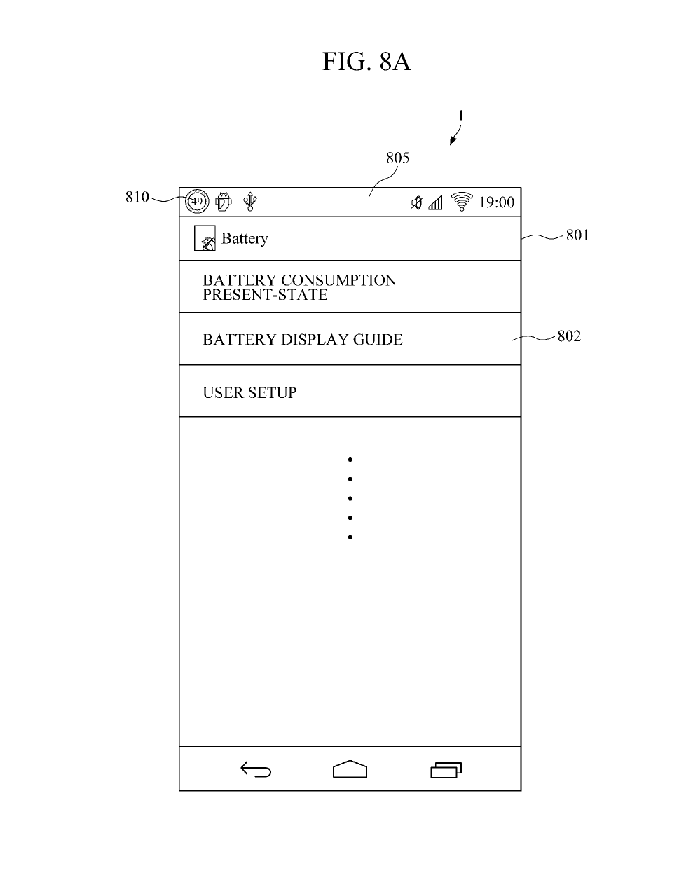

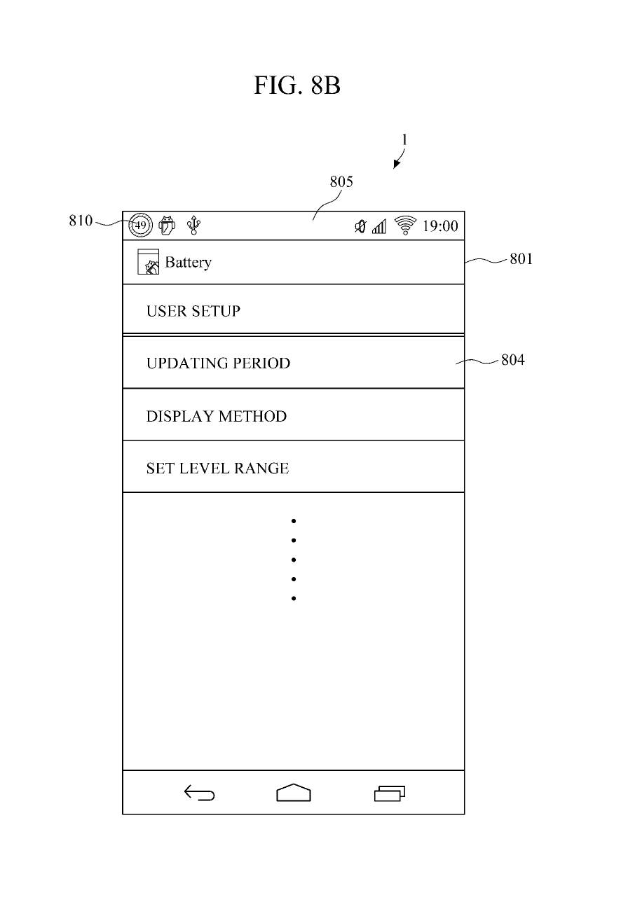

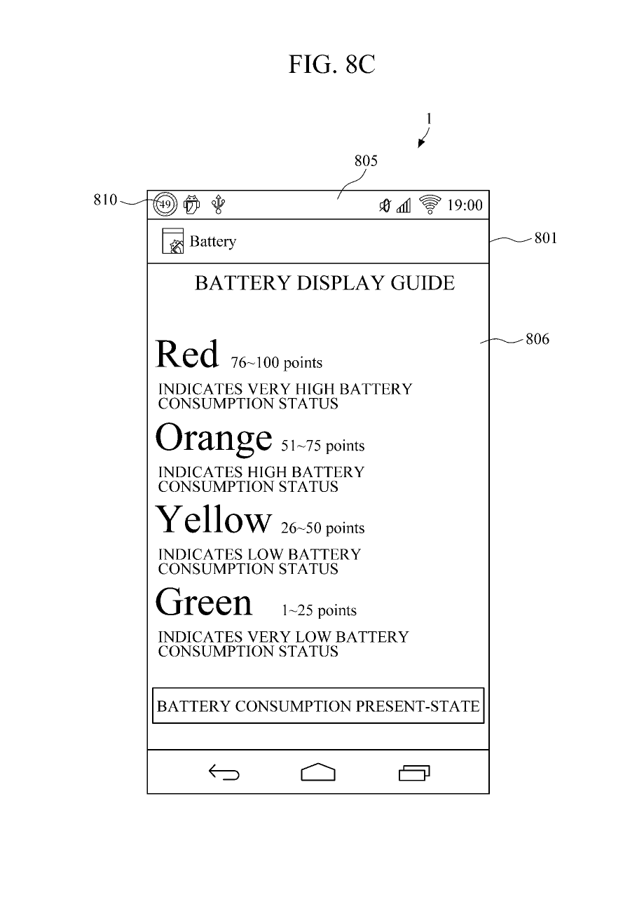

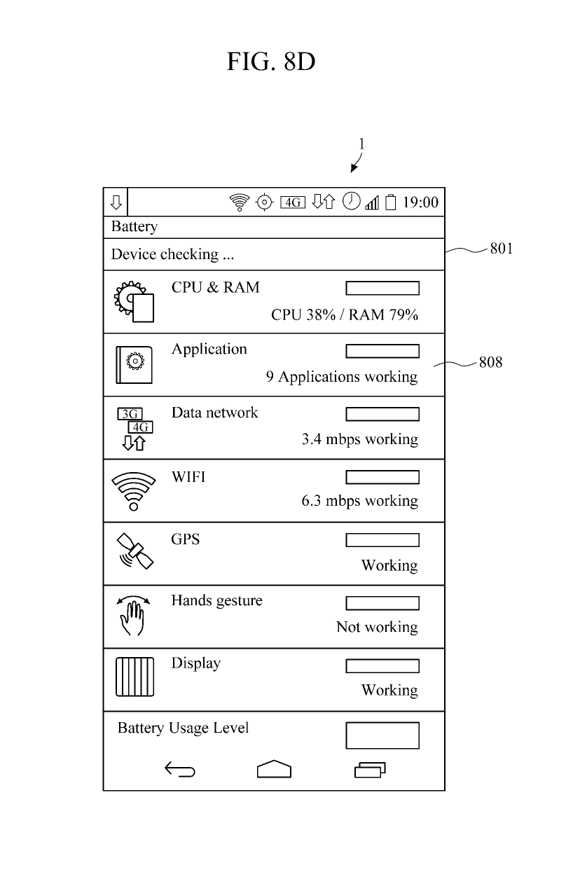

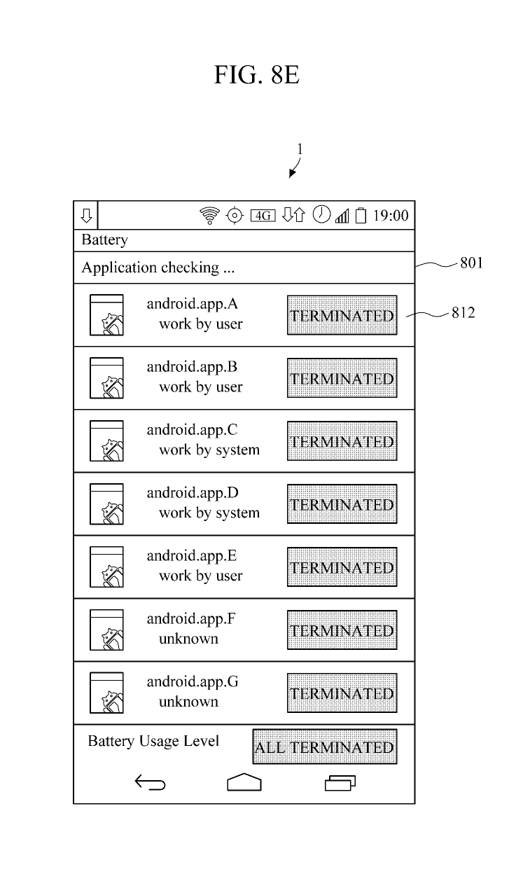

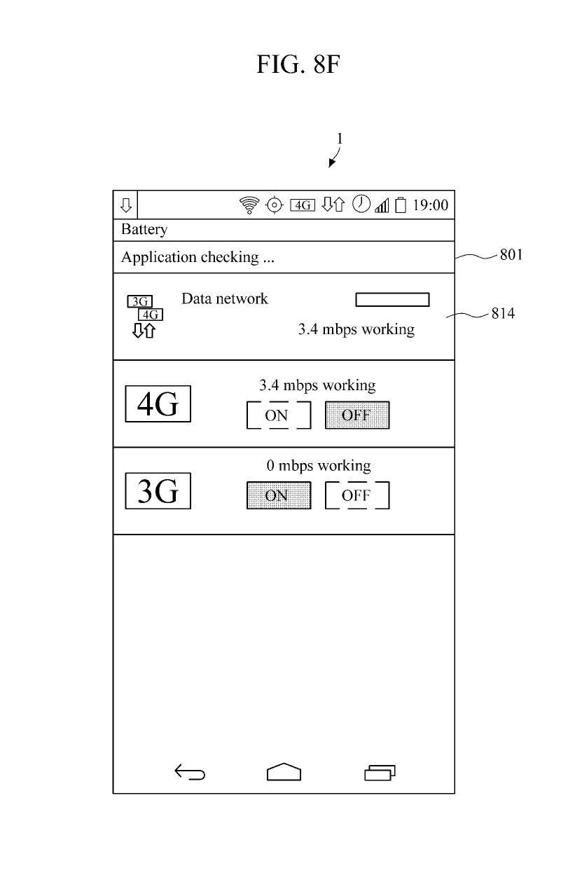

Referring to FIG. 7A, initially, a user of the portable electronic device 1 may execute a battery application at operation S401, and input user setup information corresponding to the real-time battery consumption information at operation S402. Although the exemplary embodiments describe that a display screen for inputting the user setup information is displayed after executing the battery application, the exemplary embodiments are not limited in this regard. For example, even if the battery application is not executed, a screen for inputting the user setup information regarding the battery consumption status information may be displayed on the display, such as the display 80 or the display 801 (FIG. 8A) using an environment setup menu of the portable electronic device 1, for example.

FIG. 8A is a diagram of an example of a display screen displayed on the display according to exemplary embodiments of the present invention. Referring to FIG. 8A, it can be seen that when the battery application is executed (the word ‘Battery’ displayed on a display 801 directly under the status bar 805 indicates the name of the executed application), various menus, such as a ‘battery consumption present-state’ (or battery consumption present status), a ‘battery display guide’, and a ‘user setup’, may be displayed on a display screen 802 of the display 801, for example. A battery consumption present-state or status menu may be used to display a consumption of each or one or more of the battery consumption elements of the portable electronic device 1, which are currently consuming power. Also, the battery display guide may be used to display help information or guide information, such as a detailed description of real-time battery consumption information (e.g., real-time battery consumption information displayed on the status bar 805 or in the form of a popup screen on the display 801) that may be displayed on the display, such as display 801 of the portable electronic device 1.

Referring to FIG. 7A, when the user setup menu is selected from the screen 802 of the display 801 of FIG. 8A, or when a user setup menu for battery management is selected using an environment setup application, the user may set an updating period of the real-time battery consumption information, a method of displaying the real-time battery consumption information, and a level range at operation S402. FIG. 8B illustrates a diagram of a display screen on a display of a portable electronic device according to exemplary embodiments of the present invention.

On the display screen 804 of display 801 of FIG. 8B, under ‘User Setup,’ the ‘updating period’ refers to a period at which the power consumption status of the portable electronic device 1 is determined, and the real-time battery consumption is updated based on the determination results. The ‘display method’ on the display screen 804 may refer to a method for outputting the real-time battery consumption information and include outputting visual signals, outputting audio signals, outputting the corresponding information using specific numeral values, or outputting the corresponding information at a status level, and distinguishing status levels from one another by, for example, colors or images. Also, the ‘set level range’ on the display screen 804 refers to the level, section or grade range may be set by defining a specific range of consumption marks (or power consumption) corresponding to each of the status levels, for example, according to exemplary embodiments.

Thereafter, real-time power consumption of the portable electronic device 1 may be calculated or determined at set or reference time periods at operation S403, and a present or current status level may be determined based on the real-time power consumption and the set level range at operation S404. The real-time power consumption determined at operation S403 may include information, such as, for example, the amount of CPU used and RAM occupancy of an application being executed, battery consumption of the wireless communication module, and battery consumptions of a sensor, an input/output device, and a camera, of the portable electronic device 1.

Continuing with reference to FIG. 7A it may be determined whether it is possible to display real-time battery consumption information corresponding to the current status level obtained as the determination result in operation S404 on the status display region at operation S405. The status display region may correspond to a status bar or notification bar of a smart phone or tablet computer, such as the status bar 805 of the portable electronic device 1. When it is determined in operation S405 that it is possible to display real-time battery consumption information on the status display region, the real-time battery consumption information may be displayed on the corresponding status display region or status bar 805 such as at symbol 810 in FIG. 8B (also refer to, for example, symbol 610 on status bar 605 of FIG. 6A). In this regard, the real-time battery consumption information may be displayed according to the display method set in operation S402. In contrast, when it is determined in operation S405 that it is impossible to display real-time battery consumption information on the status display region or status bar 805, the determination results may be displayed in the form of a popup screen on the display 801, or vocally output such as on the speaker output device 90 at operation S407.

From operation S406 or from operation S407, it may be determined whether an input regarding the status display region (i.e., status bar 805) is sensed at operation S408. In operation S408, it may be determined whether an input signal regarding the real-time battery consumption information output as an image on the display 801 or vocally output to sensor/input device 70, such as to a microphone as the sensor/input device 70, is received from a user of the portable electronic device 1. The input regarding the status bar 805 may refer to a user's touch input regarding the real-time battery consumption information displayed on the status bar 805, or a user's gesture input (e.g., a touch on the status bar 805 displayed at an uppermost end of the display 801 in a downward direction) received to request detailed information regarding information displayed on the status bar 805, but is not limited in this regard.

When it is determined in operation S408 that there is no input regarding the status bar 805, operations S401 to S403 may be performed again. In contrast, when it is determined in operation S408 that there is input regarding the status bar 805, notification information regarding the determination results may be displayed on the display 801 or the display 601 of FIG. 6D at operation S409 in FIG. 7B. The notification information may include a detailed description of the real-time battery consumption status, for example, a color indicating the status level of the real-time battery consumption status and a basis (e.g., a consumption mark) on which the real-time battery consumption status has the status level indicated by the corresponding color, according to exemplary embodiments.

Continuing with reference to FIG. 7B, when a user's input regarding the notification information (e.g., the user's touch input regarding the notification information of FIG. 6D) is sensed, ‘battery display guide’ information may be displayed on the display, such as display 601 or display 801 at operation S410. The battery display guide information may include a detailed description of the meaning of the real-time battery consumption information displayed on the display 601 or on the display 801 or vocally output, such as to a speaker of the audio output device 90.

FIG. 8C illustrates a diagram of battery display guide information according to exemplary embodiments of the present invention. The display screen 806 of FIG. 8C illustrates battery display guide information where real-time battery consumption information is displayed using status levels (refer to Table 1) distinguished from one another by color, for example. Referring to FIG. 8C, it can be seen that the battery display guide information on the display screen 806 of display 801 includes a description of real-time battery consumption information corresponding to each of status levels divided by colors.

In addition, a screen for displaying the battery display guide information may include a menu (battery consumption present-status menu) configured to request a present status or current status of battery consumption displayed at a bottom end of the display, but is not limited in this regard. For example, the battery consumption present-status menu may be displayed on a display screen other than the display screen for displaying the battery display guide information. For instance, as shown in FIG. 8A, the battery consumption present-status menu may be displayed on an initial screen enabled after a user executes a battery application. When a user's input regarding the battery consumption present-status menu is sensed, consumption present-status information may be displayed on the display 801 at operation S411 of FIG. 7B.

FIG. 8D illustrates a diagram of a display screen of a portable electronic device according to exemplary embodiments of the present invention. Referring to FIG. 8D, it can be seen on the display screen 808 of the display 801 that the consumption present-status information includes a present status of power consumption of each of various battery consumption elements of the portable electronic device 1 (e.g., a CPU, a RAM, applications, a data network, a WiFi, a GPS, a hand gesture, and a display) included in the portable electronic device 1.

When a user selects one battery consumption element from the present status of power consumption displayed on the display screen 808 of display 801 of FIG. 8D, a menu capable of stopping execution or operation of the corresponding battery consumption element may be displayed on the display 801 of the portable electronic device 1 at operation S412

FIG. 8E illustrates a diagram of a display screen of a portable electronic device according to exemplary embodiments of the present invention. And FIG. 8F illustrates a diagram of a display screen of a portable electronic device according to exemplary embodiments of the present invention.

Referring to FIG. 8E, it can be seen that an application list including a menu capable of ‘terminating’ an application being executed is displayed on the display screen 812 of display 801 of the portable electronic device 1. Also, referring to FIG. 8F, it can be seen that a network list including a menu capable of ‘terminating’ a data network 4G (i.e. “off”) being executed is displayed on the display screen 814 of display 801 of the portable electronic device 1.

Thus, when a menu capable of stopping execution or operation of one or more battery consumption elements of the portable electronic device 1 contributing toward battery consumption is displayed on the display 801 of the portable electronic device 1, such as on the display screen 812 of FIG. 8E and/or on the display screen 814 of FIG. 8F, a user may readily. or in a relatively short time, selectively stop or disable or may selectively enable or continue an operation of one or more battery consumption elements of the portable electronic device 1 as may unnecessarily consume power of the battery 45, or may stop one or more battery consumption elements of the portable electronic device 1 as may manage the use of the battery 45, according to exemplary embodiments, for example.

Therefore, according to exemplary embodiments, a portable electronic device can present in an easily recognizable or comprehended form real-time battery consumption information displayed on a display (e.g., a status display region or a popup screen) or vocally or audibly output, so that use of remaining battery power can be enhanced and managed relatively efficiently. Also, since the portable electronic device displays a menu capable of stopping execution of each or one or more battery consumption elements of a portable electronic device that affect battery power consumption, the portable electronic device, according to exemplary embodiments promotes efficient control of battery power consumption. Further, execution of each or one or more battery consumption elements of a portable electronic device that affect battery power consumption may be automatically selectively operated according to the battery consumption information.

Aspects of the present invention can be implemented as computer readable codes in a computer readable record medium. Also, the exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A device to manage battery power consumption, the device comprising:
one or more battery consumption elements;
a battery consumption management device to determine a real time power consumption of the one or more battery consumption elements and to determine a power consumption status of the one or more battery consumption elements based on the determined real time power consumption; and
a controller to provide real-time battery consumption information corresponding to the determined power consumption status.

2. The device of claim 1, wherein the battery consumption management device comprises:
a data collector to collect use data corresponding to battery consumption of the one or more battery consumption elements; and
a status determiner to determine the power consumption status based on the used data collected by the data collector.

3. The device of claim 2, wherein
the use data comprises information indicating if the one or more battery consumption elements of the device currently consume power and the amount of power currently consumed.

4. The device of claim 1, wherein
the one or more battery consumption elements comprise one or more applied programs to manage and control an operation or operations of the device.

5. The device of claim 1, further comprising:
a storage unit to store the real-time battery consumption information and a present status of power consumption of the one or more battery consumption elements of the device.

6. The device of claim 1, further comprising:
a storage unit comprising a current consumption database (DB) in which a reference current consumption of the one or more battery consumption elements of the device is stored, and
wherein the power consumption status of the one or more battery consumption elements is determined based on the corresponding reference current consumption.

7. The device of claim 6, wherein
the reference current consumption of the one or more battery consumption elements comprises at least one of an on-state current consumption of the corresponding battery consumption elements or a difference between the on-state current consumption and the off state current consumption of the corresponding battery consumption.

8. The device of terminal of claim 1, wherein
the determined power consumption status of the one or more battery consumption elements comprises one or more of a ratio or a percentage of a difference between the current power consumption and the minimum power consumption to a difference between the maximum power consumption and the minimum power consumption.

9. The device of claim 1, wherein
the determined power consumption status of the one or more battery consumption elements comprises a corresponding status level based on an absolute numerical value or a relative numerical value of the power consumption.

10. The device of claim 1, further comprising:
the determined power consumption status of the one or more battery consumption elements comprises a status level based on a color corresponding to the status level.

11. The device of claim 1, wherein:
the determined power consumption status of the one or more battery consumption elements comprises one or more symbols identifying the real-time battery consumption information corresponding to the determined power consumption status.

12. The device of claim 1, wherein
the real-time battery consumption information comprises a battery power remaining time indicating a time duration of battery power remaining to operate the device in a current power consumption status going forward in time, based on a battery usage level based on a currently s remaining power amount and the power amount of a completely charged battery of the device.

13. The device of claim 1, further comprising:
a power provider to generate the real-time battery consumption information corresponding to the power consumption status and to transmit the real-time battery consumption information to a display unit of the device.

14. The device of claim 1, further comprising:
a display unit to display information related with the use of a battery of the device, including the real-time battery consumption information, and to input user setup values to manage the use of the battery of the device.

15. The device of claim 14, wherein
the user setup values comprise one or more of an updating period to update the real-time battery consumption information, an arrangement to display the real-time battery consumption information, and status levels of the real-time battery consumption information.

16. The device of claim 1, wherein the controller controls operations of the one or more battery consumption elements and the battery consumption management device.

17. A method for managing battery power consumption of a device, the method comprising:
determining a real time power consumption of one or more battery consumption elements of a device;
determining a power consumption status of the one or more battery consumption elements based on the determined real time power consumption; and
providing real-time battery consumption information corresponding to the determined power consumption status.

18. The method of claim 17, further comprising:
collecting use data corresponding to battery consumption of the one or more battery consumption elements; and
determining the power consumption status based on the collected used data.

19. The method of claim 18, wherein
the use data comprises information indicating if the one or more battery consumption elements of the device currently consume power and the amount of power currently consumed.

20. The method of claim 17, further comprising:
determining a reference current consumption of the one or more battery consumption elements of the device, and
wherein determining the power consumption status of the one or more battery consumption elements is based on the corresponding reference current consumption.

21. The method of claim 20, wherein
the reference current consumption of the one or more battery consumption elements comprises at least one of an on-state current consumption of the corresponding battery consumption elements or a difference between the on-state current consumption and the off state current consumption of the corresponding battery consumption.

22. The method of claim 17, wherein
determining the power consumption status of the one or more battery consumption elements comprises determining one or more of a ratio or a percentage of a difference between the current power consumption and the minimum power consumption to a difference between the maximum power consumption and the minimum power consumption.

23. The method of claim 17, wherein
determining the power consumption status of the one or more battery consumption elements comprises determining a corresponding status level based on an absolute numerical value or a relative numerical value of the power consumption.

24. The method of claim 17, further comprising:
displaying the real-time battery consumption information on a display of the device; and
inputting user setup values to manage the use of a battery of the device based on the displayed real-time battery consumption information.

25. A method for managing battery power consumption of a device, the method comprising:
setting at least one updating period to update real-time battery consumption information of a device;
s setting a status level range for a corresponding status level of the real-time power consumption;
determining real-time power consumption of one or more battery consumption elements of the device at a corresponding updating period of the one or more set updating periods;
determining a status level of the real-time power consumption for the one or more battery consumption elements based on the determined real-time power consumption for the corresponding updating period; and
providing the real-time battery consumption information including the determined status level of the real-time power consumption for the one or more battery consumption elements for the corresponding updating period.

26. The method of claim 25, further comprising:
selectively stopping or continuing operation of the one or more battery consumption elements based on the provided real-time battery consumption information.
